(19) United States
(12) Patent Application Publication
(10) Pub. No.: US 2015/0285311 A1
(43) Pub. Date: Oct. 8, 2015

(54) CONNECTION JOINT

(71) Applicant: BELIMO Holding AG, Hinwil (CH)

(72) Inventors: Werner ARNOLD, Volketswil (CH); Andreas FURRER, Wetzikon (CH); Reto ANLIKER, Schoenholzerswilen (CH); Beat WEBER, Zuerich (CH); Georg BAMBERGER, Winterthur (CH); Urs NIEDERHAUSER, Pfungen (CH); David BALLINI, Rapperswil (CH)

(73) Assignee: BELIMO Holding AG, Hinwil (CH)

(21) Appl. No.: 14/581,892

(22) Filed: Dec. 23, 2014

(30) Foreign Application Priority Data
Apr. 2, 2014 (CH) 511/14

(51) Int. Cl. F16D 1/08; F16D 1/06

(52) U.S. Cl. CPC F16D 1/08; F16D 1/06

(57) ABSTRACT

This device has a drive output element for the actuation of a rotatable body which is separate or separable from the device, and it has a housing part in which the drive output element is rotatably mounted. The drive output element has a coupling part which is designed for rotational positive locking and which is designed to be mounted on a corresponding coupling connector of the shaft of the rotatable body. The device is characterized in that a quick-action fastener arrangement is provided for the detachable connection of the coupling part to the coupling connector. Further, the quick-action fastener arrangement can have manually actuable elements for enabling the quick-action fastener arrangement to be closed without tools.

### TECHNICAL FIELD

The invention relates to a device having
a) a drive output element for the actuation of a rotatable body which is separate or separable from the device, and
b) having a housing part in which the drive output element is rotatably mounted.

The invention relates in particular to an interface between a drive (for example a motor in a housing) and a valve of a fluid line (for example of a water line or gas line).

### SUMMARY OF THE INVENTION

The device according to the invention solves the problem of making it possible to realize simple, rapid and secure mounting of the drive onto, and removal of the drive from, the valve housing, even under difficult mounting conditions.

The solution according to the invention emerges from claim 1. The dependent claims define special embodiments.

### General Description and Advantages of the Smart Connection Joint

The Smart Connection joint is characterized by simple, rapid and secure mounting of the drive onto/removal of the drive from the valve housing, even under difficult mounting conditions. If, for example, the pipe has already been insulated and mounting using standard securing means conforming to ISO5211 would be cumbersome in this case, the strength of the Smart Connection joint becomes evident, as this can nevertheless be mounted/removed easily and rapidly. Cumbersome placement of the screws for the standard securing means is eliminated.

Comparison of Smart Connection joint and ISO5211:

### Problem of the Prior Art

Mounting of the screws in the case of the standard securing means with insulated pipes are not to be placed, or are to be placed only with great effort.

Other advantageous embodiments and combinations of features come out from the detailed description below and the totality of the claims.

### BRIEF DESCRIPTION OF THE DRAWINGS

The drawings used to explain the embodiments show:

FIG. 1 Smart Connection version 1 (V1)

FIG. 2 Smart Connection version 2 (V2)

FIG. 3a Smart Connection joint version 2

FIG. 3b Smart Connection joint version 1

FIG. 4 Standard securing means conforming to ISO5211

FIG. 5 Smart Connection V1, assembled

FIG. 6a,b Smart Connection V1, exploded illustration

FIG. 7 Connection of the housing base of the drive V1 and standard securing means conforming to ISO5211

FIG. 8a,b Valve flange V1

FIG. 9 Clamping stirrup V1

FIG. 10 Smart Connection V2, assembled

FIG. 11a,b Smart Connection V2, exploded illustration

FIG. 12 Connection of housing base of the drive V2 and standard securing means conforming to ISO5211

FIG. 13 Valve flange V2

FIG. 14a,b Clamping collar V2

FIG. 15 Smart Connection V1 with spacer adapter, assembled

FIG. 16a,b Smart Connection V1 with spacer adapter, exploded illustration

FIG. 17 Connection of the housing base of the drive V1 and standard securing means conforming to ISO5211

FIG. 18a,b Valve flange V1

FIG. 19 Clamping stirrup V1

FIG. 20a,b Spacer adapter V1

FIG. 21a,b Extension V1

FIG. 22 Connecting lever V1

FIG. 23 Smart Connection V2 with spacer adapter, assembled

FIG. 24a,b Smart Connection V2 with spacer adapter, exploded illustration

FIG. 25 Connection of the housing base of the drive V2 and standard securing means conforming to ISO5211

FIG. 26 Valve flange V2

FIG. 27a,b Clamping collar V2

FIG. 28a,b Spacer adapter V2

FIG. 29a,b Extension V2

FIG. 30 Connecting lever V2

FIG. 31a-e Extension Kit

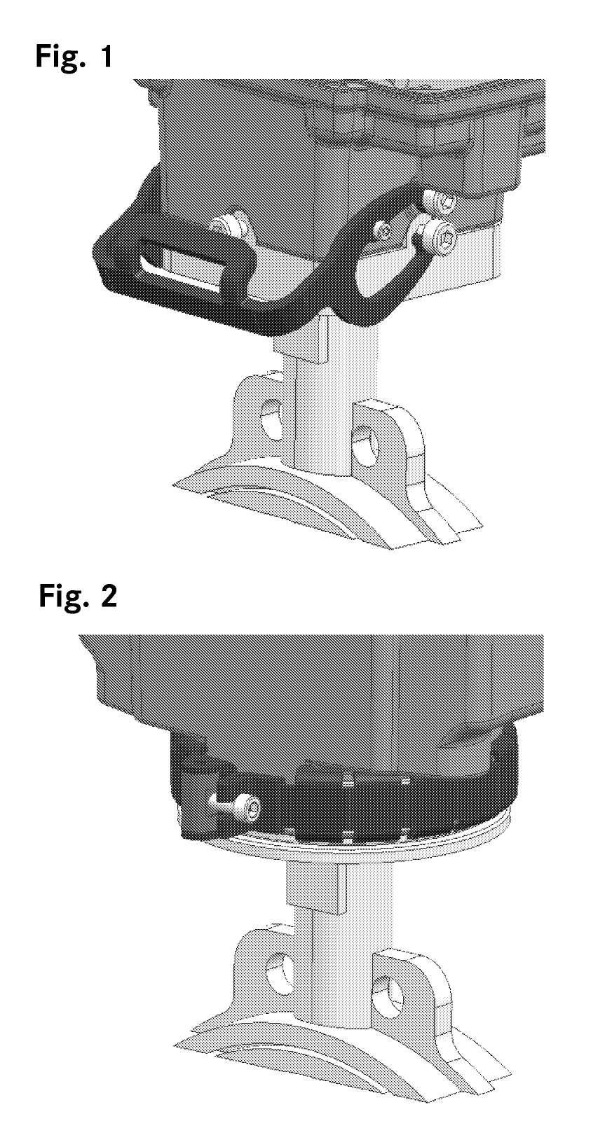

In the figures, the same components are given the same reference symbols.

### PREFERRED EMBODIMENTS

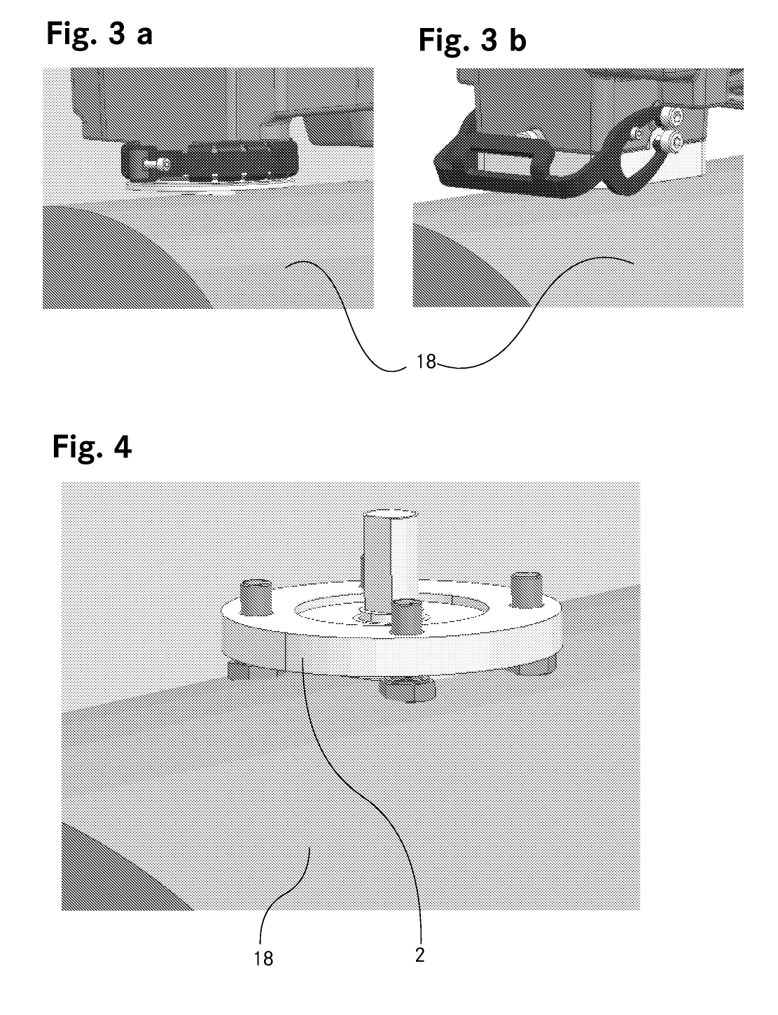

FIGS. 3a and b show two smart connection joints. There is an insulation 18.

FIG. 4 shows a standard securing means conforming to ISO5211 with a flange connector 2.

1 Smart Connection V1:

1.1 General Construction

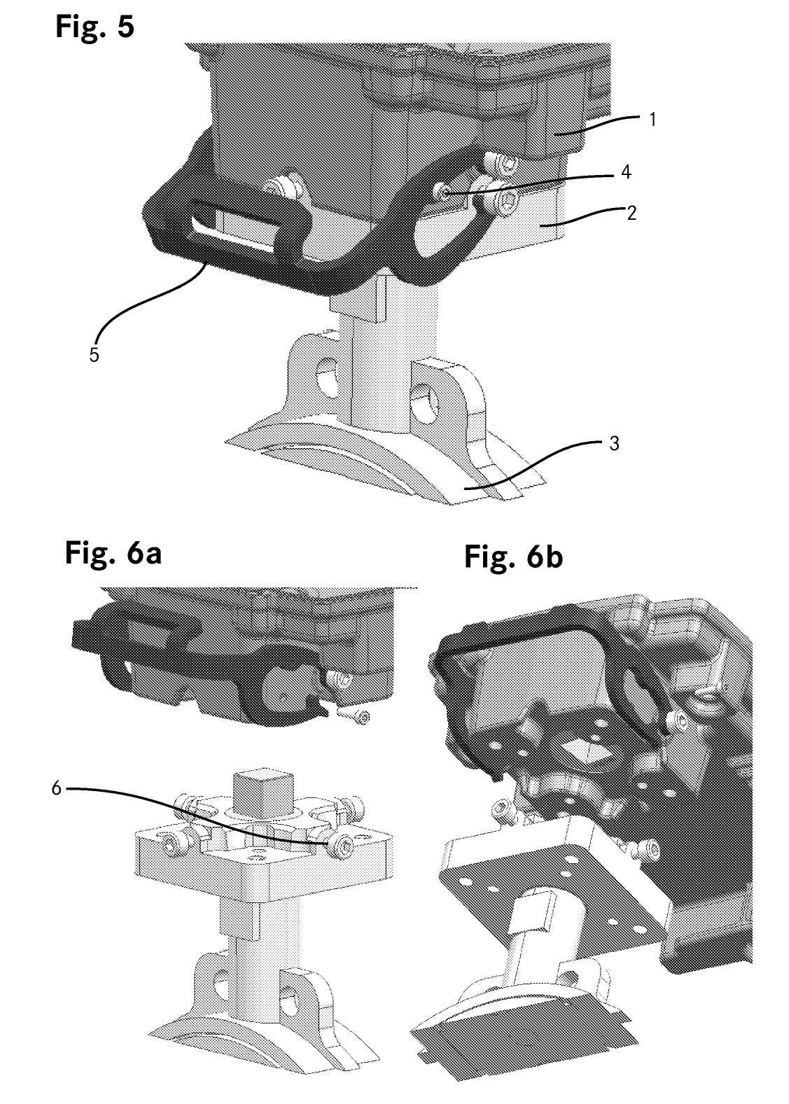

The following text refers to FIG. 5: “Smart Connection V1, assembled”.

The clamping stirrup 5 is a manually actuable element of the quick-action fastener arrangement for enabling the quick-action fastener arrangement to be closed without tools. The quick-action fastener arrangement is, in the above example, formed by the pivotable (for example U-shaped) clamping stirrup 5 with the two-armed clamping fork. One arm of the clamping fork is mounted rotatably on the housing base 1. The other arm may engage around a protruding element (for example a bolt) which is attached to the valve flange 2. The clamping fork can, owing to its design, hold the housing base 1 firmly on the valve flange 2 with a certain clamping force. When the second arm of the clamping fork engages behind the counterpart element on the valve flange (for example the above-mentioned bolt), a detent action is preferably realized.

The central part of the clamping stirrup 5 is in the form of a handle. The quick-action fastener arrangement that is shown thus has, in a preferred embodiment, a single manually operable actuation element, specifically the handle on the central part of the clamping stirrup 5. Said (single) actuation element activates both clamping forks at the two ends of the U-shaped stirrup simultaneously. Thus, two clamping-force elements (which are parallel with respect to the axis of rotation of the drive output) are activated substantially simultaneously.

The securing element 4 is part of a securing device for preventing inadvertent release of the quick-action fastener arrangement. The securing device can for example be released only using a tool (for example a screwdriver or spanner), but not by hand. It is however also possible for securing devices to be used that can be released by hand, for example an additional small bolt with spring element or a splint.

The valve whose valve housing 3 is illustrated is an example of a rotatable body which is separate or separable from the drive.

The manually actuable element, in this case the clamping stirrup 5, protrudes only a short distance beyond the housing part. In this way, the quick-action fastener can be used even in restricted spaces. In particular, the actuation element bears substantially (with at most a small spacing of 1-2 cm) against the housing part in the initial position (before closing) or in the final position (after closing).

1.2 Assembly

The following text refers to FIG. 6a (left) and FIG. 6b (right): “Smart Connection V1, exploded illustration”.

In FIGS. 6a and b, the valve is separate from the drive. As a protruding element on the valve connector part, it is now possible to see the counter bracket 6 on which the clamping stirrup 5 can engage.

In the center of the coupling connector of the valve, the square end of the shaft of the rotatable body of the valve can be seen. Said square end is an element of the coupling connector. It can be inserted into a correspondingly square opening in the drive output element of the drive. The drive output element, specifically the circular insert with the depression with square socket, can be seen in FIG. 6b on the underside of the housing.

The device is designed such that it can be mounted, by way of the coupling part (which is attached for example to the base of the drive housing), to the coupling connector of the valve in an axial direction with respect to the shaft of the valve.

1.3 Details of the Individual Parts

1.3.1 Housing Base of the Drive V1

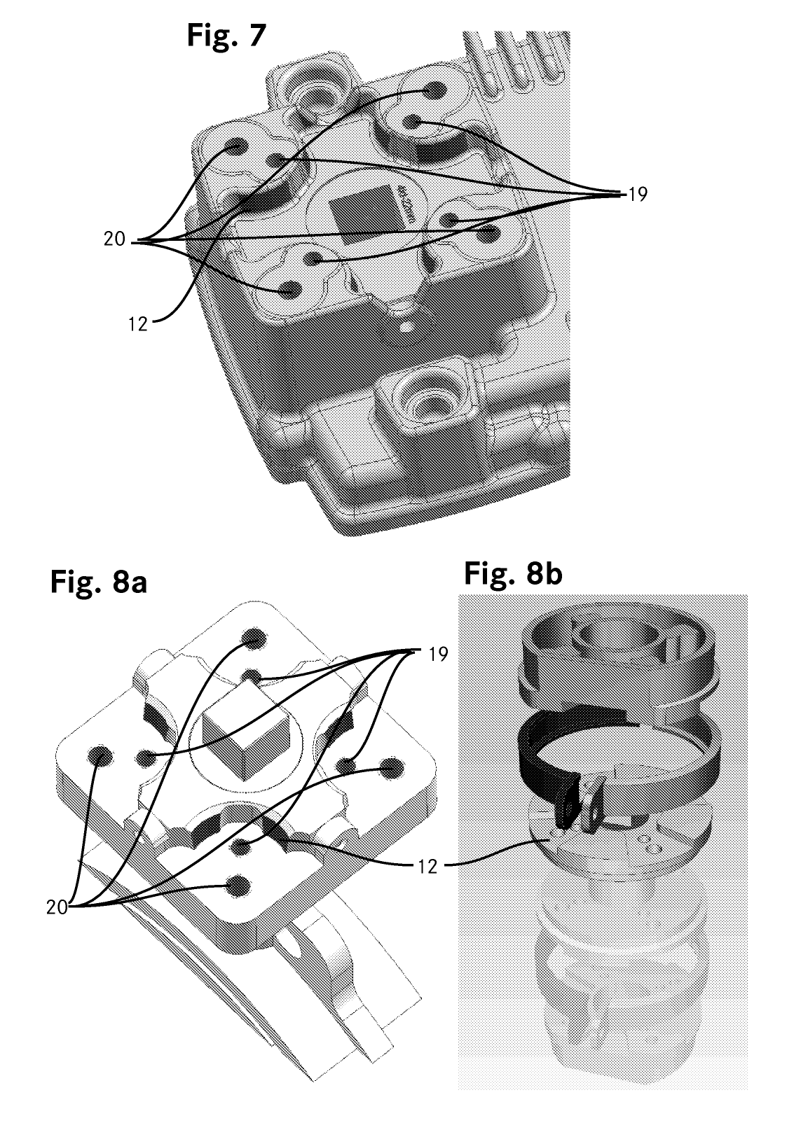

The following text refers to FIG. 7 “Connection of the housing base of the drive V1 and standard securing means conforming to ISO5211”.

The flange connector may be fastened either by means of a standard securing means conforming to ISO5211 F07 or F10 (a thread in each case) (19, 20) or by means of the Smart Connection. In the case of the Smart Connection variant, the position of the drive with respect to the pipeline is determined by the Smart Connection system surface 12, which serves as a rotation prevention means. Said Smart Connection system surface 12 may be inclined or even vertical.

In FIG. 7, the housing part on which the Smart Connection system surface 12 is formed is substantially square. The Smart Connection system surface has 4-fold rotational symmetry. A rotatable coupling part is provided in the center of the housing part. In the present example, the coupling part is formed by a depression or opening with a square socket. The coupling part can thus assume four different angular positions, offset with respect to one another in each case by 90°, when mounted on the flange of the valve or on the coupling connector thereof. The system surface 12 comprises, in a certain sense, a cloverleaf shape.

The drive can be fastened to the valve either by means of a conventional ISO screw connection or by means of the quick-action fastener arrangement according to the invention, because the correspondingly dimensioned boreholes (in particular two sets of boreholes) are formed in the system surface 12.

Table 1: ISO5211

TABLE 1
Maximum flange torque values

| Flange type | Maximum flange torque Nm |
|---|---|
| F03 | 32 |
| F04 | 63 |
| F05 | 125 |
| F07 | 250 |
| F10 | 500 |
| F12 | 1 000 |
| F14 | 2 000 |
| F16 | 4 000 |
| F25 | 8 000 |
| F30 | 16 000 |
| F35 | 32 000 |
| F40 | 63 000 |
| F48 | 125 000 |
| F60 | 250 000 |

Source: http://www.wirematic.se/DBFiles/iso5211-2001(e).PDF

1.3.2 Valve Flange V1

The following text refers to FIG. 8a and FIG. 8b “Valve flange V1”.

The valve flange has the same bore layout as the housing base of the drive. The Smart Connection system surface 12 may in this case also be inclined or vertical, the principle being the same as that for the housing base of the drive. The Smart Connection system surface 12 may also be of some other shape (see the FIG. 8b).

1.3.3 Clamping Stirrup V1

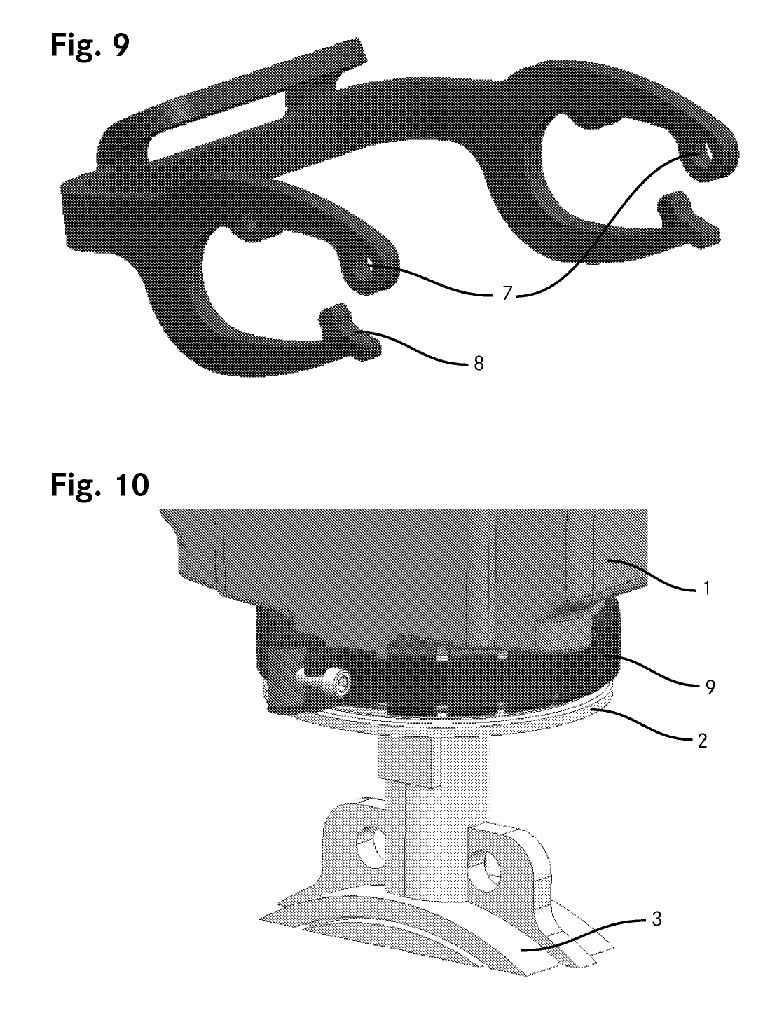

The following text refers to FIG. 9 “Clamping stirrup V1”.

The clamping stirrup clamps the housing base of the drive together with the valve flange (including valve housing), wherein a securing element prevents an inadvertent release of the connection.

The clamping stirrup comprises fastenings to the drive housing 7 and detent or clamping surfaces 8.

2 Smart Connection V2:

2.1 General Construction

The following text refers to FIG. 10 “Smart Connection V2, assembled”.

In FIG. 10, the housing base 1 of the drive is connected to the valve flange 2 by means of an annular mechanism, specifically the clamping collar 9. The annular mechanism is for example of similar design to a hose clamp or a hose clip. That is to say it can be placed around the connecting point in the manner of a collar and then clamped. During the clamping process, the circumference of the clip element is reduced, resulting in a radially inwardly directed clamping force. By means of suitably inclined contact surfaces between the clip element, situated at the outside, and the coupling parts, situated at the inside, the radial clamping force is converted into an axial clamping force running parallel to the axis of the drive output element or of the valve.

2.2 Assembly

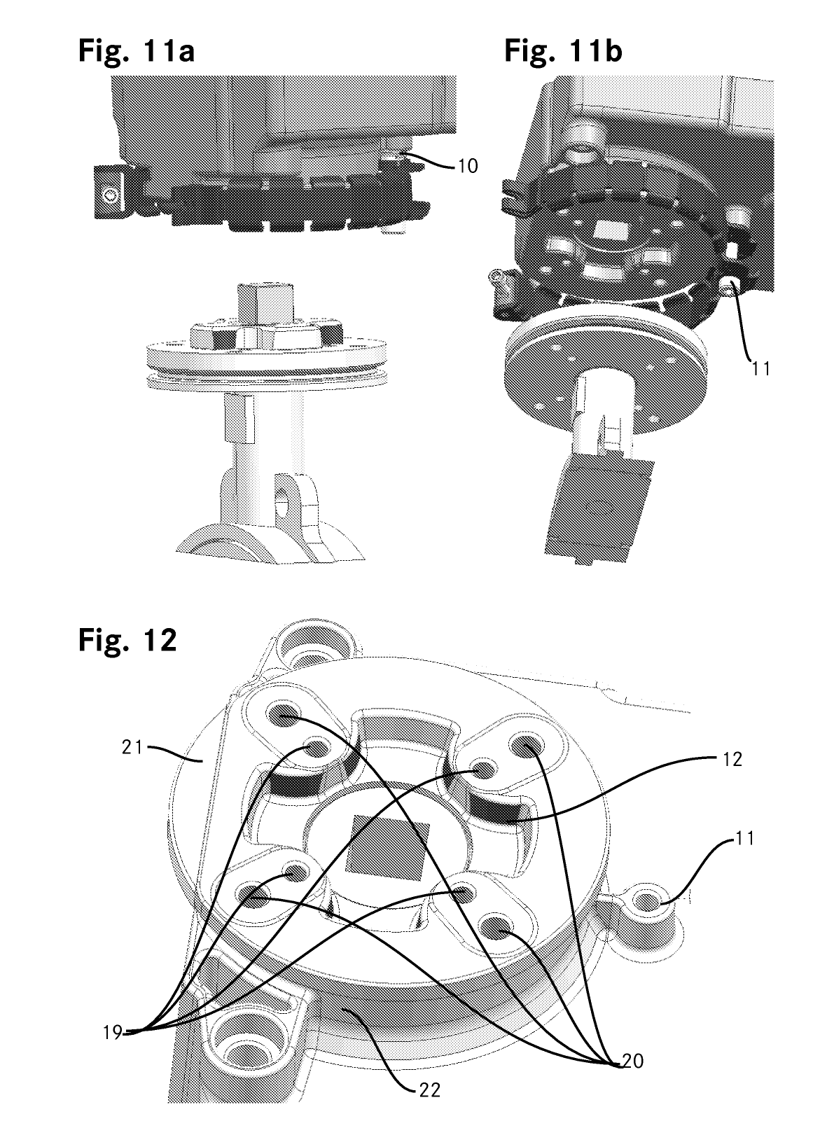

The following text refers to FIG. 11 “Smart Connection V2, exploded illustration”.

The clamping collar halves are fastened to the housing base of the drive by means of a clamping collar bracket 11. It is the task of the restoring spring 10, when the clamping collar is in the open state, to hold said clamping collar open so wide that the valve flange can be easily mounted. The open state is restricted by a stop. By closing the clamping collar by means of a clamping element, screw, quick-action fastener, etc., the valve flange including valve housing is connected firmly to the housing base of the drive.

2.3 Details of the Individual Parts

2.3.1 Housing Base of the Drive V2

The following text refers to FIG. 12: “Connection of housing base of the drive and standard securing means conforming to ISO5211”.

The clamping collar bracket 11 is fastened to the housing base of the drive, wherein the clamping collar engages at one side into the engagement undercut of the housing base of the drive and at the other side into the engagement undercut of the valve flange (see 2.3.2).

The standard securing means and the mode of operation of the Smart Connection system surface are identical to the Smart Connection V1.

The cylinder surface at the engagement undercut 22, and the undercut itself, may also be of flat form (see flat surface at engagement undercut 21).

2.3.2 Valve Flange V2

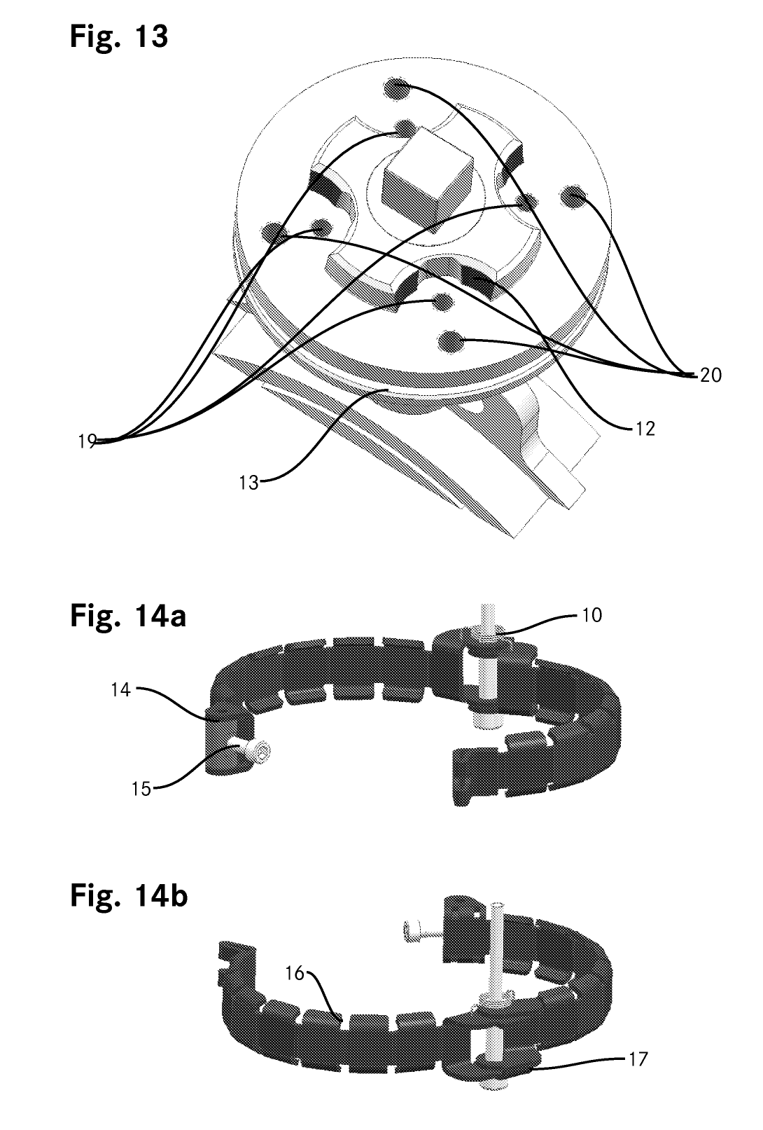

The following text refers to FIG. 13: “Valve flange V2”.

The function of the engagement undercut of the clamping collar 13 has already been explained in the preceding chapter. The Smart Connection system surface 12 principle is identical to the Smart Connection V1.

2.3.3 Clamping Collar V2

The following text refers to FIG. 14a and FIG. 14b: “Clamping collar V2”.

The restoring spring 10 forces the two clamping collars against a stop 17 in the open state.

The cutouts 16 of the two clamping collars can but do not have to be provided. It may also be continuously curved without cutouts 16.

It can be seen in FIGS. 14a and b that the quick-action fastener arrangement comprises two semicircular arcuate parts which are connected, at one of their ends, by means of a bolt as an axis of rotation. The restoring spring 10 is for example wound around the bolt and supported with its ends on in each case one of the arcuate parts such that the arcuate parts are forced into an open position. On one of the semicircular arcuate parts there is formed a stop 17 for the other arcuate part, such that the open position is defined.

A clamping element 15 (clamping screw) is provided on the free end of one arcuate part, and an opening into which the clamping element 15 can be inserted is provided on the free end of the other arcuate part. The free ends of the arcuate parts can thus be pulled together by means of the clamping element 15.

On each arcuate part there are formed tab elements which are separated from one another by cutouts 16 and which are directed toward the center of the semicircle axis of the respective arcuate part. Said tab elements engage around the flange of the valve and of the drive and have the effect that the coupling part of the drive is pressed onto the coupling connector of the valve during the clamping of the quick-action fastener arrangement.

14 is a clamping element receptacle.

3 Smart Connection V1 with Spacer Adapter:

3.1 General Construction

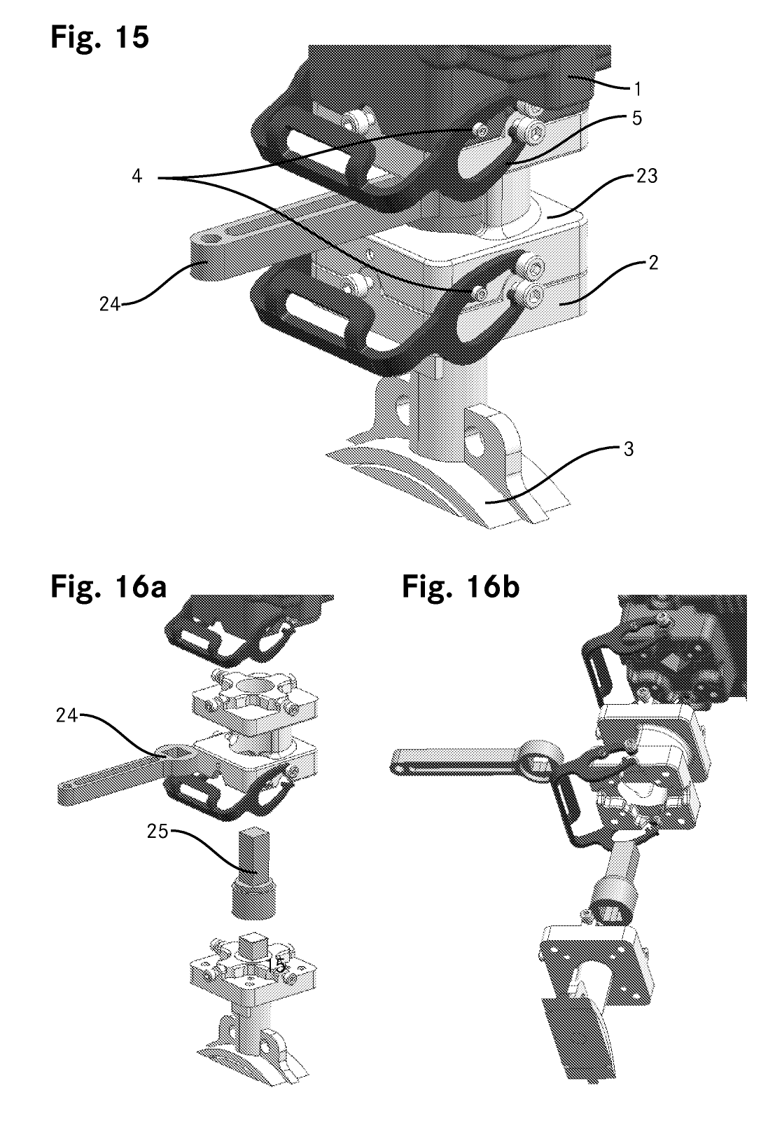

The following text refers to FIG. 15: “Smart Connection V1 with spacer adapter, assembled”.

The spacer adapter 23 serves firstly for enabling two valves to be actuated using only one drive with the aid of the connecting lever 24 (3-way application) and secondly for improved thermal insulation. It may also be an intermediate adapter which serves only for thermal insulation.

It can be seen in FIG. 15 that the spacer adapter 23 likewise has a quick-action fastener arrangement similar to the first embodiment V1.

The connecting lever 24 is mechanically connected to a second valve (not illustrated), such that the single drive actuates two valves simultaneously. The second valve may for example be installed in a fluid line that is parallel to the first fluid line.

3.2 Assembly

The following text refers to FIG. 16a (left) and FIG. 16b (right): “Smart Connection V1 with spacer adapter, exploded illustration”.

There is a connecting lever with reference number 24 and an extension with reference number 25.

3.3 Details of the Individual Parts

3.3.1 Housing Base of the Drive V1

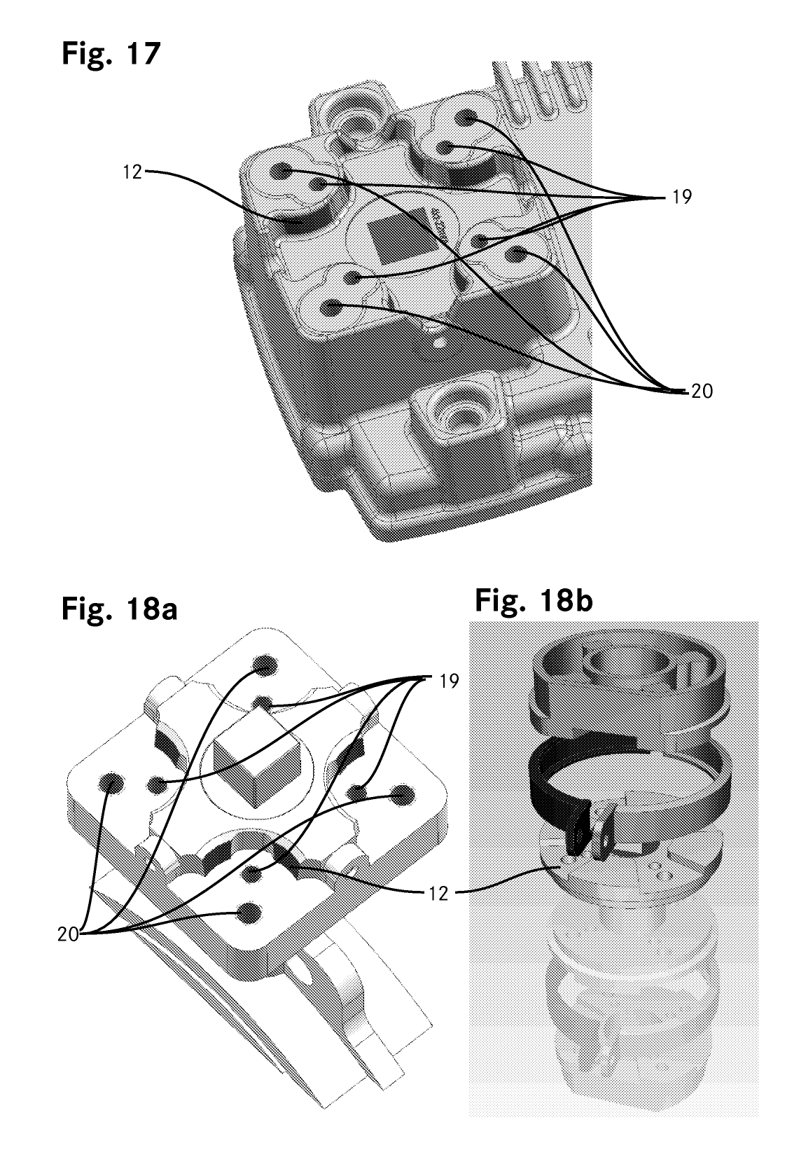

The following text refers to FIG. 17: “Connection of the housing base of the drive V1 and standard securing means conforming to ISO5211”.

The flange connector may be fastened either by means of a standard securing means conforming to ISO5211 F07 or F10 (a thread in each case) (19, 20) or by means of the Smart Connection. In the case of the Smart Connection variant, the position of the drive with respect to the pipeline is determined by the Smart Connection system surface 12, which serves as a rotation prevention means. Said Smart Connection system surface 12 may be inclined or even vertical.

ISO5211:

TABLE 1
Maximum flange torque values

| Flange type | Maximum flange torque Nm |
|---|---|
| F03 | 32 |
| F04 | 63 |
| F05 | 125 |
| F07 | 250 |
| F10 | 500 |
| F12 | 1 000 |
| F14 | 2 000 |
| F16 | 4 000 |
| F25 | 8 000 |
| F30 | 16 000 |
| F35 | 32 000 |
| F40 | 63 000 |
| F48 | 125 000 |
| F60 | 250 000 |

Source: http://www.wirematic.se/DBFiles/iso5211-2001(e).PDF

3.3.2 Valve Flange V1

The following text refers to FIGS. 18a and b: “Valve flange V1”

The valve flange has the same bore layout as the housing base of the drive. The Smart Connection system surface 12 may in this case also be inclined or vertical, the principle being the same as that for the housing base of the drive. The Smart Connection system surface 12 may also be of some other shape (see FIG. 18b).

3.3.3 Clamping Stirrup V1

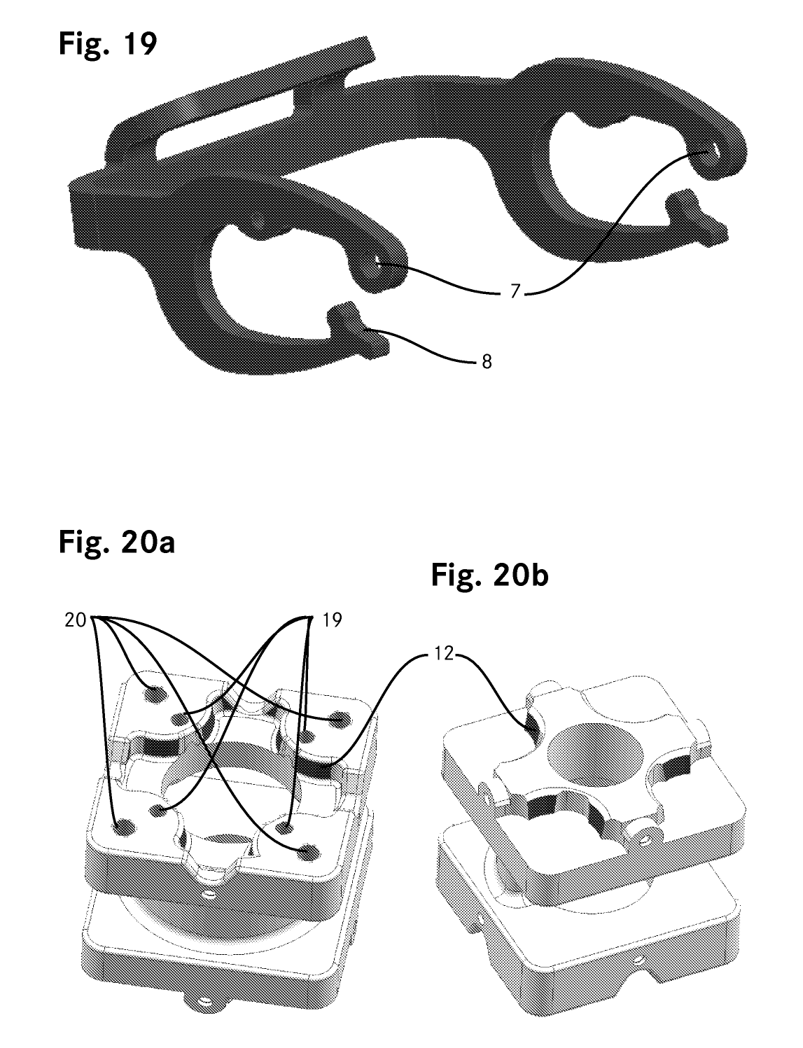

The following text refers to FIG. 19: “Clamping stirrup V1”.

The clamping stirrup clamps the housing base of the drive together with the valve flange (including valve housing), wherein a securing element prevents an inadvertent release of the connection.

3.3.4 Spacer Adapter V1

The following text refers to FIG. 20a (left) and FIG. 20b (right): “Spacer adapter V1”.

The spacer adapter connects the housing base of the drive to the valve flange. The mode of operation of the Smart Connection system surface 12 is the same as in the case of Smart Connection V1 without adapter.

3.3.5 Extension V1

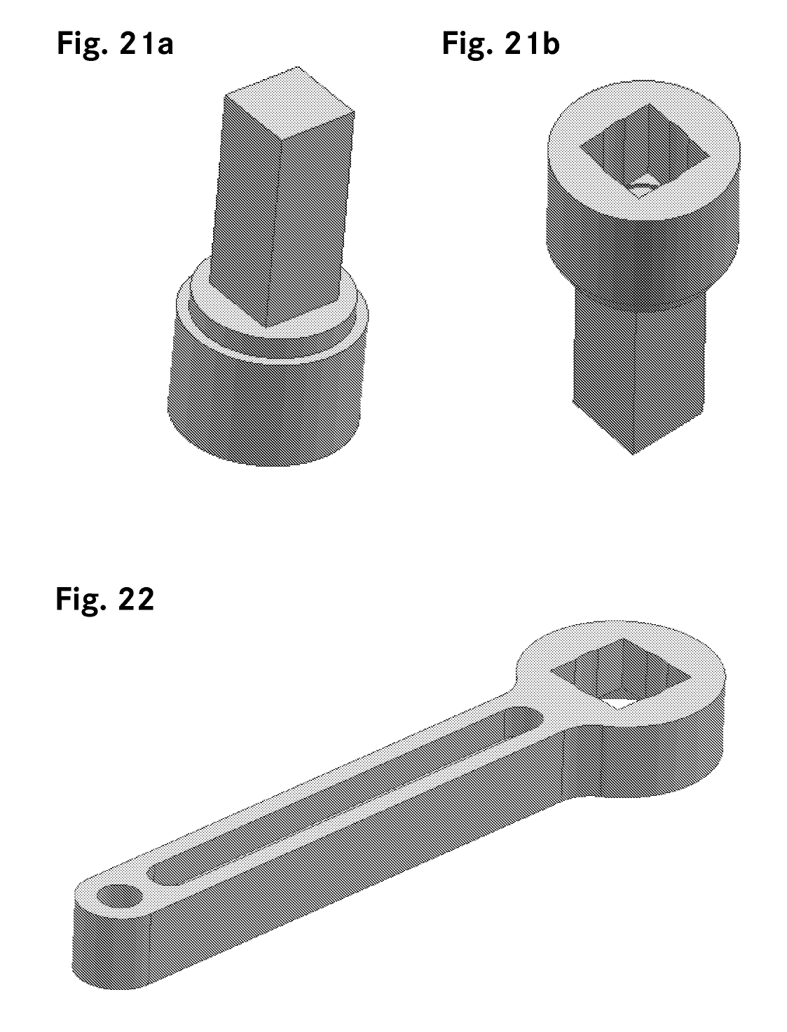

The following text refers to FIG. 21a (left) and FIG. 21b (right): “Extension V1”.

The extension transmits the torque from the drive side to the valve flap. It additionally defines the position of the connecting lever and thus permits the actuation of two valves simultaneously. One end of the extension is provided with a coupling connector with external square and the other is provided with a coupling part with square socket. It is thus possible for the drive output of the drive to be plugged onto one side and for the shaft end of the rotary body of the valve to be plugged onto the other side.

3.3.6 Connecting Lever V1

The following text refers to FIG. 22: “Connecting lever V1”

The connecting lever serves for the actuation of two valves using only one drive (3-way application).

It has, at the outer end, for example, an opening for a bolt of a coupling rod. At the inner end, it has an opening with a square socket for the extension shown in FIGS. 21a and b.

4 Smart Connection V2 with Space Adapter:

4.1 General Construction

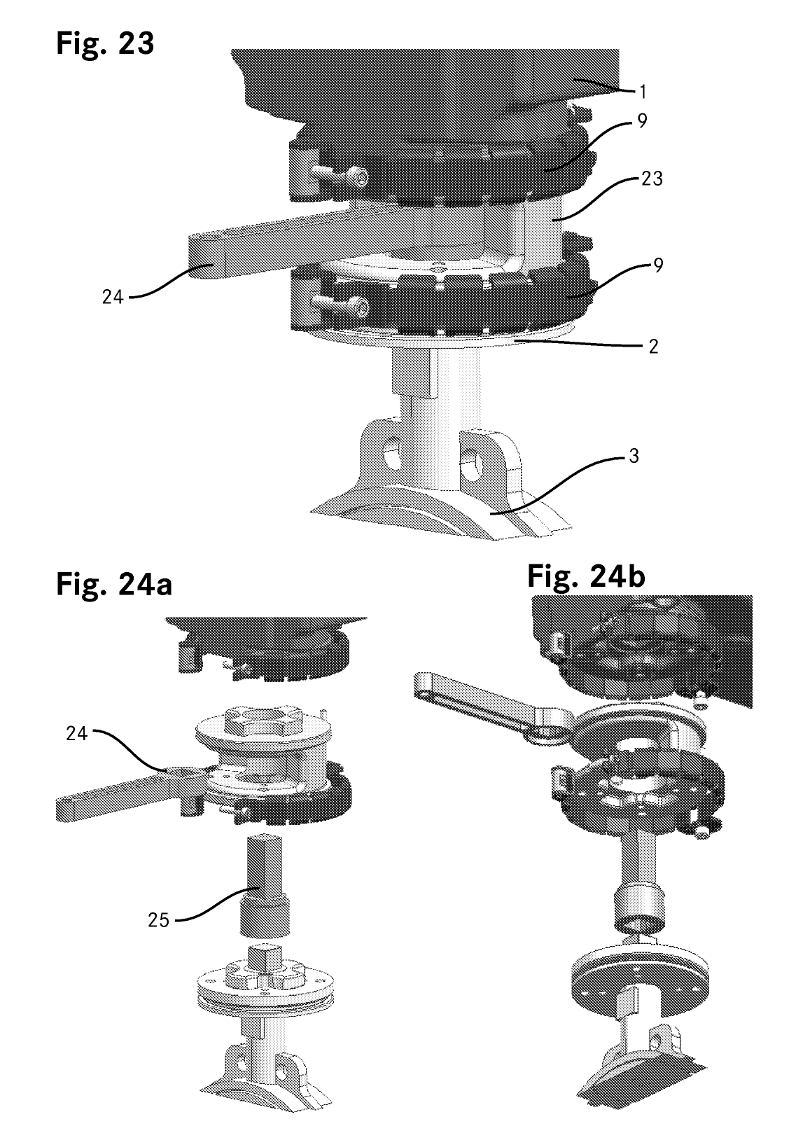

The following text refers to FIG. 23: “Smart Connection V2 with spacer adapter, assembled”.

The spacer adapter 23 serves firstly for enabling two valves to be actuated using only one drive with the aid of the connecting lever 24 (3-way application) and secondly for improved thermal insulation.

4.2 Assembly

The following text refers to FIG. 24a (left) and FIG. 24b (right): “Smart Connection V2 with spacer adapter, exploded illustration”.

There is a connecting lever with reference number 24 and an extension with reference number 25.

4.3 Details of the Individual Parts

4.3.1 Housing Base of the Drive V2

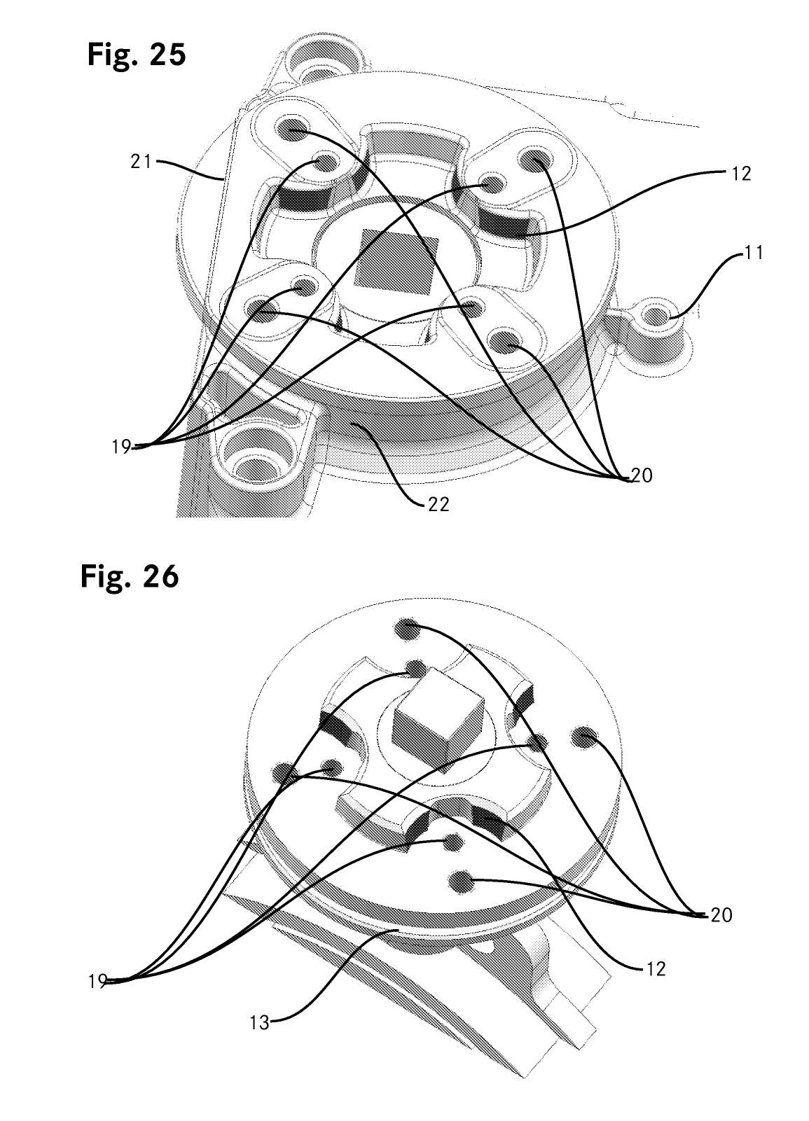

The following text refers to FIG. 25: “Connection of the housing base of the drive and standard securing means conforming to ISO5211”

The clamping collar bracket 11 is fastened to the housing base of the drive, wherein the clamping collar engages at one side into the engagement undercut 22 of the housing base of the drive and at the other side into the engagement undercut of the valve flange (see 2.3.2).

The standard securing means and the mode of operation of the Smart Connection system surface 12 are identical to the Smart Connection V1.

The cylinder surface at the engagement undercut, and the undercut 22 itself, may also be of flat form (see flat surface at engagement undercut 21).

4.3.2 Valve Flange V2

The following text refers to FIG. 26: “Valve flange V2”.

The function of the engagement undercut of the clamping collar 13 has already been explained in the preceding chapter. The Smart Connection system surface 12 principle is identical to the Smart Connection V1.

4.3.3 Clamping Collar V2

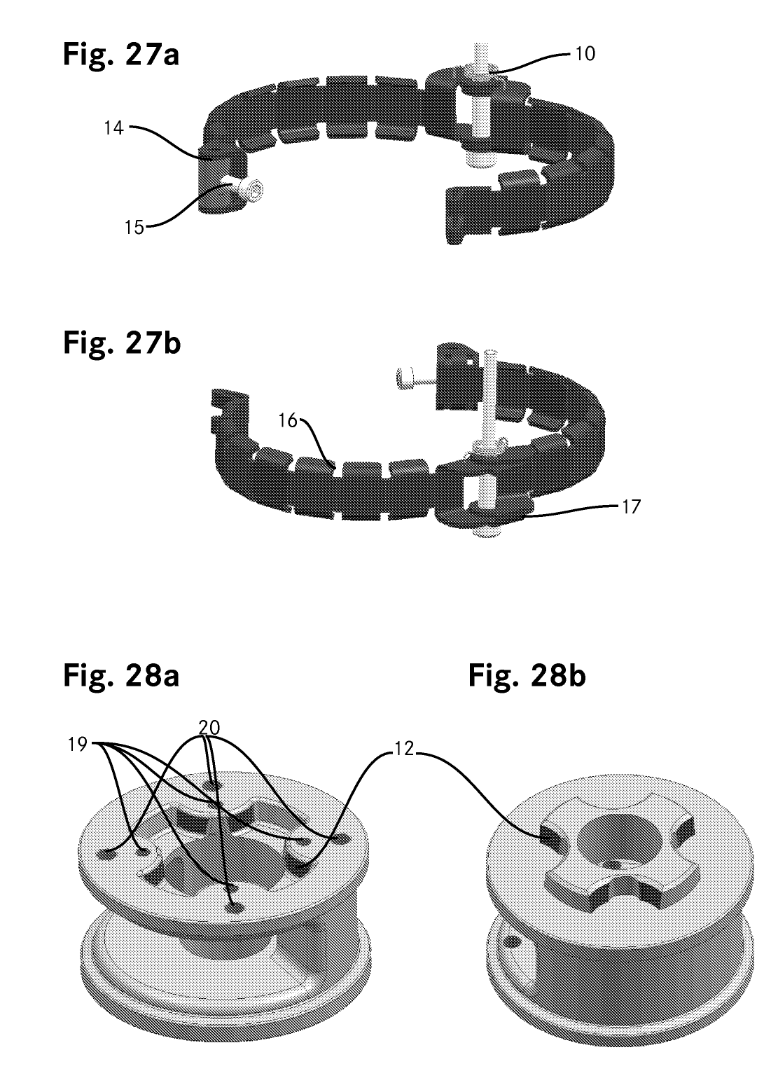

The following text refers to FIG. 27a (top) and FIG. 27b (bottom): “Clamping collar V2”.

The restoring spring 10 forces the two clamping collars against a stop 17 in the open state.

The cutouts 16 of the two clamping collars can but do not have to be provided. It may also be continuously curved without cutouts.

4.3.4 Spacer Adapter V2

The following text refers to FIG. 28a (left) and FIG. 28b (right): “Spacer adapter V2”.

The spacer adapter connects the housing base of the drive to the valve flange. The mode of operation of the Smart Connection system surface 12 is the same as in the case of Smart Connection V2 without adapter.

The spacer adapter has a plate-shaped connection flange at each of its two ends. One is of male form (for example with a protruding cloverleaf element) and the other is of female form (for example with a cloverleaf-shape depression).

The axially extending intermediate part between the two connection flanges has a radially accessible free space for the connecting lever. The free space has for example an opening angle of 180°.

4.3.5 Extension V2

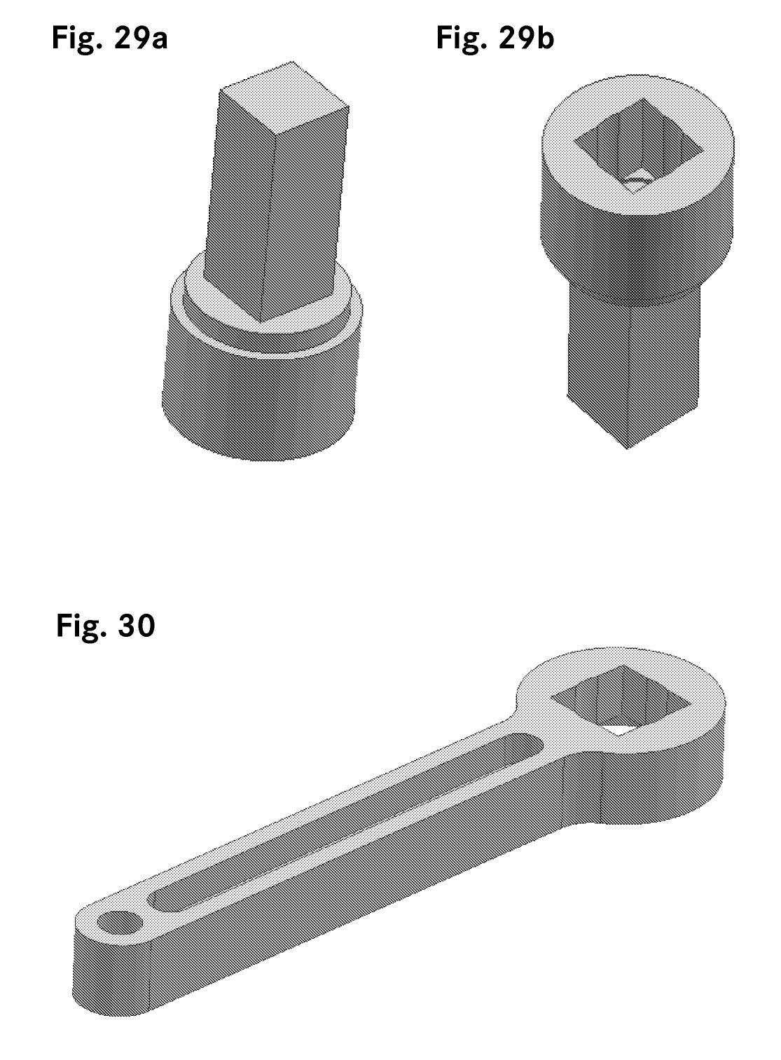

The following text refers to FIG. 29a (left) and FIG. 29b (right): “Extension V2”.

The spacer adapter connects the housing base of the drive to the valve flange. It additionally defines the position of the connecting lever and thus permits the actuation of two valves simultaneously.

4.3.6 Connecting Lever V2

The following text refers to FIG. 30: “Connecting lever V2”.

The connecting lever serves for the actuation of two valves using only one drive (3-way application). It corresponds, for example, to that of FIG. 22.

5 Extension Kit QCV

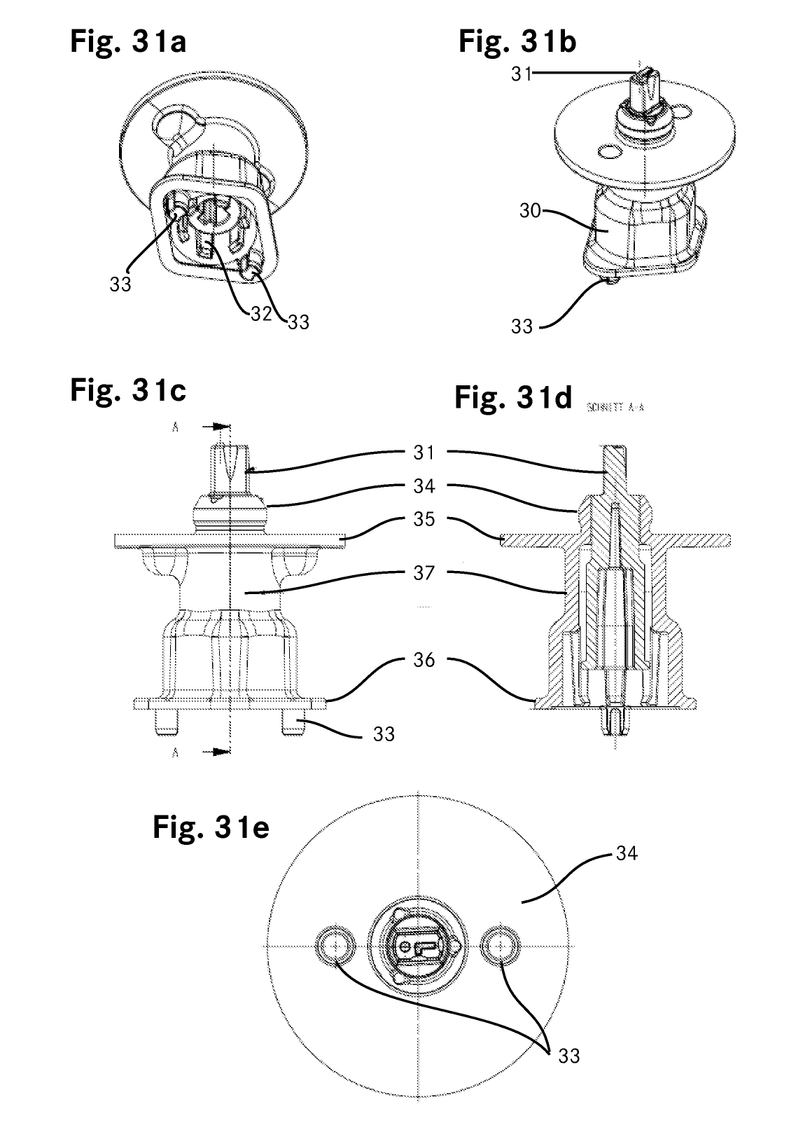

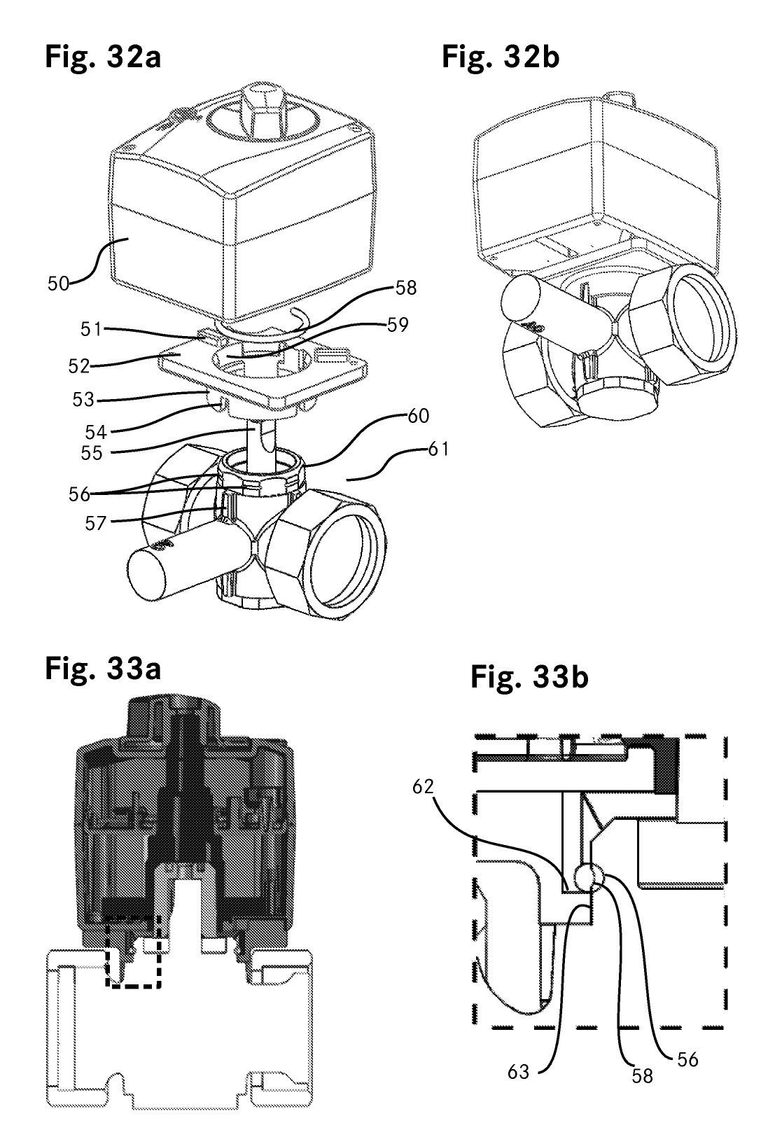

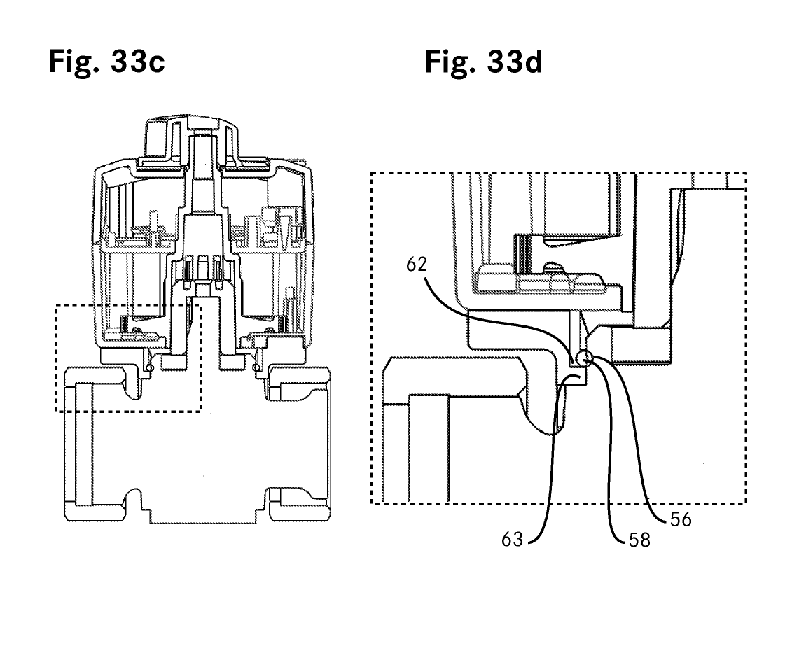

FIGS. 31a-e show a device for increasing the distance between a coupling part of a valve and a connector part of a drive unit. In principle, said device for increasing the distance may be used analogously to a spacer adapter as per FIGS. 16a and b. Said coupling part of a valve may for example be designed analogously to the valve flange (2) in FIG. 13 or FIG. 15. The connector part of a drive unit is illustrated correspondingly for example in FIG. 17.

The device (extension kit) has a housing (30, 37) in which a shaft (31) is rotatably mounted. Furthermore, said device has a first and a second adapter structure for connecting, on the one hand, to the coupling part of the valve and, on the other hand, to the connector part of the drive unit (not illustrated in FIGS. 31a-e). The shaft extends from the first to the second adapter structure. The housing (30, 37) has, on the upper end, for example, a plate-shaped flange (35) to which the drive (for example an electric motor with gear mechanism) can be fastened. The overall diameter of the plate-shaped flange (35) is, in the embodiment shown, larger than the maximum dimension of the housing (30, 37) at the open (lower) side. Two fastening openings, for example, are provided in the flange. At the lower side, the housing (30,37) is formed in the manner of an open pipe (possibly with a narrow flange 36). At two diametrically opposite locations (in the corners in FIG. 31a) of the open lower side, there are provided two pegs, which project out of the housing (30,37) in an axial direction, for alignment and for fixing with respect to the direction of rotation of the shaft (31). It is also possible for more than two pegs to be provided. Instead of pegs, it is also possible for differently-shaped projections (ribs etc.) to be provided. Alternatively, depressions for receiving ribs or pegs on a coupling part of a valve and on a connector part of a drive unit may be provided on the housing (30,37). In very general terms, these constitute a positioning aid 33 or a fixing aid.

At least in the case of one of the adapter structures (that is to say either in the case of the upper adapter structure or in the case of the lower adapter structure, or in the case of both adapter structures), a resilient clamping device is provided in order to make it possible to realize a connection, which can be created without tools, to the coupling part and/or to the connector part. In FIG. 31a, the clamping device is formed by 6 regularly arranged resilient arms (32). The arms (32) run substantially parallel to the shaft (31) and, on their free ends, each have a section which projects toward the center, that is to say a type of detent lug. Said detent lugs can engage behind a collar or other projection on the coupling part of the valve. The device can thus be fixedly clamped to the valve, or engaged on the valve with detent action, without using tools.

In an analogous embodiment, the same mechanism may also be provided on the top side of the device in the direction of the connector part of the drive unit.

The device preferably has, at least in the case of one of the adapter structures, a structure that can be engaged behind in order to make it possible to realize a connection, which can be created without tools, to the coupling part or to the connector part. FIGS. 31c and 31d respectively show a type of ball head and a radially protruding ring. Between said ball head or protruding ring, respectively, and the plate-shaped upper flange 35, there is formed an encircling channel into which a clamping device (for example the resilient arms shown in FIG. 31a) can engage 34.

As can be seen from FIG. 31a, at least one of the adapter structures has a flange which provides a contact surface for a corresponding flange on the coupling part or on the connector part.

The resilient clamping device is preferably arranged within an envelope defined by the housing 30, 37. However, it is also conceivable for the clamping device to be arranged on the outside of the housing 30, 37.

### LIST OF REFERENCE SYMBOLS

| | |
|---|---|
| 1 | Housing base of the drive |
| 2 | Flange connector; Valve flange |
| 3 | Valve housing |
| 4 | Securing element (e.g. screw, pin, wire, plate, splint, etc.) |
| 5 | Clamping stirrup |
| 6 | Counter bracket for clamping stirrup |
| 7 | Fastening to the drive housing |
| 8 | Detent surface/Clamping surface |
| 9 | Clamping collar |
| 10 | Restoring spring |
| 11 | Clamping collar bracket |
| 12 | Smart Connection system surface |
| 13 | Engagement undercut for clamping collar |
| 14 | Clamping element receptacle |
| 15 | Clamping element |
| 16 | Cutouts |
| 17 | Stop |
| 18 | Insulation |
| 19 | Standard securing means conforming to ISO5211 - F07 (flange type) |
| 20 | Standard securing means conforming to ISO5211 - F10 (flange type) |
| 21 | Flat surface at engagement undercut |
| 22 | Engagement undercut for the clamping collar |
| 23 | Spacer adapter |
| 24 | Connecting lever |
| 25 | Extension |
| 30 | Housing |
| 31 | Shaft |
| 32 | Resilient arms |
| 33 | Positioning aid |
| 34 | Structure that can be engaged behind |
| 35 | Plate-like flange |
| 36 | Flange |
| 37 | Housing |

1. A device having
a) a drive output element for the actuation of a rotatable body which is separate or separable from the device, and
b) having a housing part in which the drive output element is rotatably mounted,
c) wherein the drive output element has a coupling part which is designed for rotational positive locking and which is designed to be mounted on a corresponding coupling connector of the shaft of the rotatable body,
d) characterized in that a quick-action fastener arrangement is provided for the detachable connection of the coupling part to the coupling connector.

2. The device according to claim 1, characterized in that the quick-action fastener arrangement has manually actuable elements for enabling the quick-action fastener arrangement to be closed without tools.

3. The device according to claim 1, characterized in that the quick-action fastener arrangement is designed to generate between the coupling connector and coupling part a clamping force which is axial with respect to the axis of rotation of the drive output element.

4. The device according to claim 1, characterized in that the quick-action fastener arrangement has a single manually operable actuation element, in particular a lever or a stirrup, which activates one or more axial clamping-force elements substantially simultaneously.

5. The device according to claim 1, characterized in that said device is designed to be mountable by way of the coupling part onto the coupling connector in an axial direction with respect to the shaft.

6. The device according to claim 1, characterized in that the manually actuable element protrudes only a short distance beyond the housing part, in particular in that said manually actuable element bears against the housing part in the initial position (before closing) or in the final position (after closing).

7. The device according to claim 1, characterized in that the coupling part has at least four different angular positions, preferably offset with respect to one another by 90°, in which a connection to the coupling connector is possible, in particular in that said four angular positions are realized by means of a cloverleaf shape.

8. The device according to claim 1, characterized in that the quick-action fastener arrangement is a ring clamp.

9. The device according to claim 1, characterized in that said device has a securing device for preventing undesired release of the quick-action fastener arrangement, wherein the securing device can preferably be released only with the use of a tool (that is to say not by hand).

10. The device according to claim 1, characterized in that the quick-action fastener arrangement has at least two positions, specifically an open position and a closed position, in which it is held by springs or by the detent action.

11. The device according to claim 1, characterized in that, in addition to the quick-action fastener arrangement, bores for an ISO-standardized screw connection are provided.

12. The device according to claim 1, characterized in that the coupling part has a square profile.

13. The device according to claim 1, characterized in that the coupling part has conical surfaces for play-free coupling.

14. The device according to claim 1, characterized in that the housing part is a part of a drive housing, which encases preferably an electric motor and optionally a gear mechanism.

15. The drive, which is suitable for the actuation of a valve of a fluid line, characterized in that said drive has a device according to claim 1.

16. The equipment set comprising a drive according to claim 15 and a valve, characterized in that the valve is designed for being coupled to the drive by means of a device having
a) a drive output element for the actuation of a rotatable body which is separate or separable from the device, and
b) having a housing part in which the drive output element is rotatably mounted,
c) wherein the drive output element has a coupling part which is designed for rotational positive locking and which is designed to be mounted on a corresponding coupling connector of the shaft of the rotatable body,
d) characterized in that a quick-action fastener arrangement is provided for the detachable connection of the coupling part to the coupling connector.

17. A device for increasing the distance between a coupling part of a valve and a connector part of a drive unit, wherein the device comprises the following:
e) a housing in which a shaft is rotatably mounted,
f) a first and a second adapter structure for connecting, on the one hand, to the coupling part of the valve and, on the other hand, to the connector part of the drive unit,
g) wherein the shaft extends from the first to the second adapter structure.

18. The device according to claim 17, characterized in that said device has, at least for one of the adapter structures, a resilient clamping device for making it possible to realize a connection, which can be created without tools, to the coupling part or to the connector part.

19. The device according to claim 17, characterized in that said device has, at least for one of the adapter structures, a structure which can be engaged behind in order to make it possible to realize a connection, which can be created without tools, to the coupling part or to the connector part.

20. The device according to claim 18, characterized in that the resilient clamping device has at least one resilient arm, and in that said at least one resilient arm preferably extends substantially parallel to the shaft.

21. The device according to claim 17, characterized in that at least one of the adapter structures comprises a flange which provides a contact surface for a corresponding flange on the coupling part or on the connector part.

22. The device according to claim 18, characterized in that the resilient clamping device is arranged within an envelope defined by the housing.

23. The device according to claim 18, characterized in that the adapter structure has at least one protruding peg or at least one depression for receiving a peg in order to position the adapter structure relative to the coupling part or the connector part.

24. The device according to claim 1, characterized in that the quick-action fastener arrangement has the following:
h) a depression on a housing of the rotatable body,
i) a depression on a receptacle which surrounds the housing of the rotatable body in a connecting region, and
j) a securing ring (or circlip) which fits, between the housing and receptacle, into the depressions.

25. The device according to claim 24, characterized in that the housing of the rotatable body is substantially circular in the connecting region, and in that a fixing element in the form of a protruding element or a depression is provided at at least one location, wherein the fixing element cooperates with a fitting element on the receptacle in order to form a rotation prevention means.

26. The device according to claim 24, characterized in that the receptacle has a flange to which the housing part of the drive output element can be fastened, and in that at least one positioning aid, in particular a rib or a groove, is provided on the flange.
